(19) United States
(12) Patent Application Publication
(10) Pub. No.: US 2015/0317556 A1
(43) Pub. Date: Nov. 5, 2015

(54) ADAPTIVE QUICK RESPONSE CONTROLLING SYSTEM FOR SOFTWARE DEFINED STORAGE SYSTEM FOR IMPROVING PERFORMANCE PARAMETER

(71) Applicant: PROPHETSTOR DATA SERVICES, INC., Taichung (TW)

(72) Inventors: Ming Jen HUANG, Taichung (TW); Chun Fang HUANG, Taichung (TW); Tsung Ming SHIH, Taichung (TW); Wen Shyen CHEN, Taichung (TW)

(73) Assignee: PROPHETSTOR DATA SERVICES, INC., Taichung (TW)

(21) Appl. No.: 14/265,916

(22) Filed: Apr. 30, 2014

(51) Int. Cl. G06N 3/08; H04L 29/08; H04L 12/24

(52) U.S. Cl. CPC G06N 3/08; H04L 41/5009; H04L 67/1097

(57) ABSTRACT

An adaptive quick response controlling system for a software defined storage (SDS) system to improve a performance parameter is disclosed. The system includes: a traffic monitoring module, for acquiring an observed value of the performance parameter in a storage node; an adaptive dual neural module, for learning best configurations of a plurality of storage devices in the storage node under various difference values between the observed values and a specified value of the performance parameter from historical records of configurations of the storage devices and associated observed values, and providing the best configurations when a current difference value is smaller than a threshold value; and a quick response control module, for changing a current configuration of the storage devices in the storage node as the best configuration of the storage devices provided from the adaptive dual neural module if the current difference value is not smaller than the threshold value.

### FIELD OF THE INVENTION

The present invention relates to a controlling system for software defined storage. More particularly, the present invention relates to a controlling system for software defined storage to achieve specified performance indicators required by Service Level Agreement (SLA).

### BACKGROUND OF THE INVENTION

Cloud services had been very popular in the recent decade. Cloud services are based on cloud computing to provide associated services or commodities without increasing burden on client side. Cloud computing involves a large number of computers connected through a communication network such as the Internet. It relies on sharing of resources to achieve coherence and economies of scale. At the foundation of cloud computing is the broader concept of converged infrastructure and shared services. Among all the shared services, memory and storage are definitely the two having maximum demand. This is because some hot applications, such as video streaming, require huge quantity of data to be stored. Management of memories and storages while the cloud services operate is very important to maintain normal service quality for the clients.

For example, a server used for providing cloud services usually manages or links to a number of Hard Disk Drives (HDDs). Clients access the server and data are read from or written to the HDDs. There are some problems, e.g. latency of response, due to limitation of the HDD system. Under normal operation of HDD system, the latency is usually caused by requirements of applications (i.e. workload), as the required access speed is higher than that the HDD system can support. Thus, the HDD system is a bottleneck to the whole system for the cloud service and reaches beyond the maximum capacity it can provide. Namely, the Input/Output Operations per Second (IOPS) of the HDD system cannot meet the requirements. For this problem, it is necessary to remove or reduce the workload to achieve and improve the efficiency of the server. In practice, partial of the workload can be shared by other servers (if any) or other HDDs are automatically or manually added on-line to support current HDDs. No matter which one of the above methods is used to settle the problem, its cost is to reserve a huge amount of HDDs for unexpected operating condition and necessary power consumption for the extra hardware. From an economic point of view, it is not worthy doing so. However, the shortest latency or minimum IOPS may be contracted in Service Level Agreement (SLA) and has to be practiced. For operators which have limited capital to maintain the cloud service, how to reduce the cost is an important issue.

It is worth noting that workload of the server (HDD system) more or less can be predicted in a period of time in the future based on historical records. Possibly, a trend of development of the requirement for the cloud service can be foreseen. Therefore, reconfiguration of the HDDs in the HDD system can be performed to meet the workload with minimum cost. However, a machine is not able to learn how and when to reconfigure the HDDs. In many circumstances, this job is done by authorized staff according to real time status or following stock schedule. Performance may not be very good.

Another increasing demand as well as the cloud service is software defined storage. Software defined storage refers to computer data storage technologies which separate storage hardware from the software that manages the storage infrastructure. The software enabling a software defined storage environment provides policy management for feature options, such as deduplication, replication, thin provisioning, snapshots and backup. With software defined storage technologies, there are several prior arts providing solutions to the aforementioned problem. For example, in US Patent Application No. 20130297907, a method for reconfiguring a storage system is disclosed. The method includes two main steps: receiving user requirement information for a storage device and automatically generating feature settings for the storage device from the user requirement information and a device profile for the storage device; and using the feature settings to automatically reconfigure the storage device into one or more logical devices having independent behavioral characteristics. Throughout the text of the application, it points out a new method to reconfigure storage devices by the concept of software defined storage. The method and system according to the application can also allow users to dynamically adjust configuration of the one or more logical devices to meet the user requirement information with more flexibility. However, the application fails to provide a system which is able to automatically learn how to reconfigure storage devices according to the changes of the requirements of applications (i.e. workload).

Therefore, the present invention discloses a new system to implement automatic learning and resource relocation for a software defined storage. It utilizes an adaptive control and operates without human intervention.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

According to an aspect of the present invention, an adaptive quick response controlling system for a software defined storage (SDS) system to improve a performance parameter includes: a traffic monitoring module, for acquiring an observed value of the performance parameter in a storage node; an adaptive dual neural module, for learning best configurations of a plurality of storage devices in the storage node under various difference values between the observed values and a specified value of the performance parameter from historical records of configurations of the storage devices and associated observed values, and providing the best configurations when a current difference value is not smaller than a threshold value; and a quick response control module, for changing a current configuration of the storage devices in the storage node as the best configuration of the storage devices provided from the adaptive dual neural module if the current difference value is not smaller than the threshold value. The storage node is operated by SDS software and the current difference value will be reduced after the best configuration is adopted.

The adaptive dual neural module comprises: a constant neural network element, for providing the best configurations which are preset before the adaptive quick response controlling system functions when the current difference value is not smaller than a tolerance value; and an adaptive neural network element, for learning the best configurations of the storage devices in the storage node under various difference values from the historical records of configurations of the storage devices and associated observed values in a long period and providing the best configurations when the current difference value is smaller than the tolerance value but not smaller than the threshold value.

Preferably, when the constant neural network element operates, the adaptive neural network element stops operating or when the adaptive neural network element operates, the constant neural network element stops working. The tolerance value is less than or equal to a preset value. In practice, the preset value is preferred to be 3 seconds. The long period ranges from tens of seconds to a period of the historical records. The observed values in the long period are not continuously recorded. A change amount between the best configuration provided by the constant neural network element and the current configuration is greater than that between the best configuration provided by the adaptive neural network element and the current configuration. Learning the best configurations of the storage devices is achieved by Neural Network Algorithm. The specified value is requested by a Service Level Agreement (SLA) or a Quality of Service (QoS) requirement. The performance parameter is Input/Output Operations per Second (IOPS), latency or throughput. The storage devices are Hard Disk Drives (HDDs), Solid State Drives, Random Access Memories (RAMs) or a mixture thereof. The best configuration is percentages of different types of storage devices or a fixed quantity of storage devices of single type in use.

The adaptive quick response controlling system further includes a calculation module, for calculating the difference value and passing the calculated difference value to the adaptive dual neural module and the quick response control module. Preferably, the traffic monitoring module, adaptive dual neural module, quick response control module or calculation module is hardware or software executing on at least one processor in the storage node.

### BRIEF DESCRIPTION OF THE DRAWINGS

FIG. 1 illustrates a block diagram of an adaptive quick response controlling system in an embodiment according to the present invention.

FIG. 2 shows an architecture of a storage node.

FIG. 3 is a flow chart of operation of the adaptive dual neural module.

FIG. 4 is a table for a best configuration from the adaptive dual neural module.

### DETAILED DESCRIPTION OF THE PREFERRED EMBODIMENT

The present invention will now be described more specifically with reference to the following embodiment.

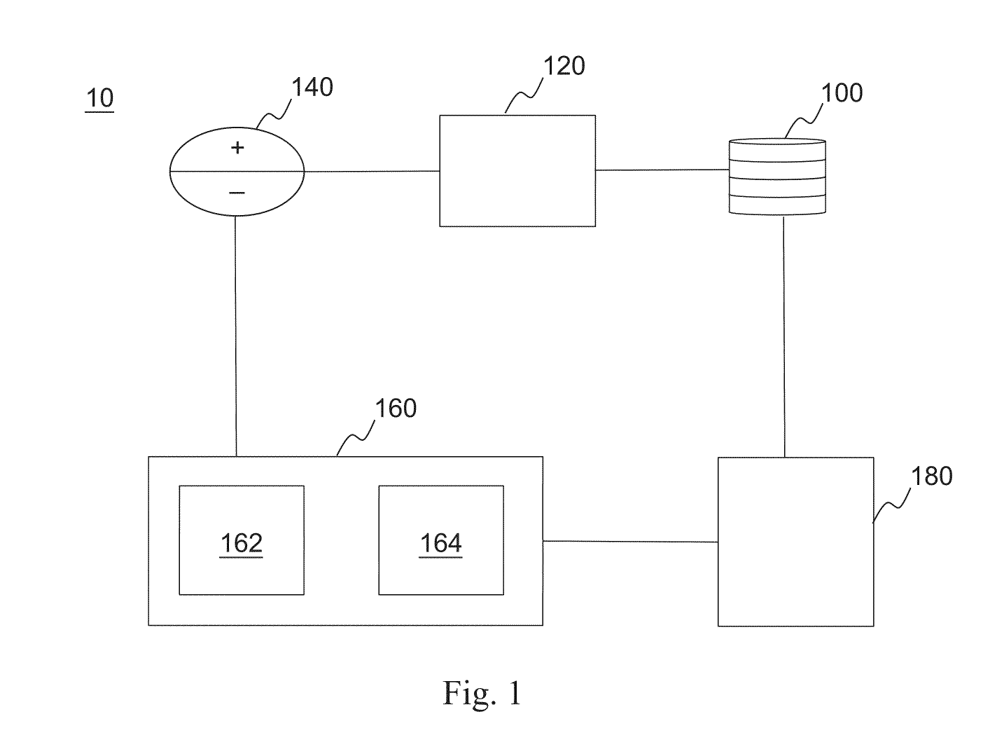

Please refer to FIG. 1 to FIG. 4. An embodiment according to the present invention is disclosed. FIG. 1 is a block diagram of an adaptive quick response controlling system 10. The system can improve a performance parameter, such as Input/Output Operations per Second (IOPS), latency or throughput for a software defined storage (SDS) system in a network. In the embodiment, the SDS system is a storage node 100 and latency of data acquiring from the SDS system is used for illustration. The network may be internet. Thus, the storage node 100 may be a database server managing a number of storages and providing cloud services to clients. It may also be a file server or a mail server with storages for private use. The network can thus be a Local Area Network (LAN) for a lab or a Wide Area Network (WAN) for a multinational enterprise, respectively. Application of the storage node 100 is not limited by the present invention. However, the storage node 100 must be a SDS. In other words, the hardware (storage devices) of the storage node 100 should be separated from the software which manages the storage node 100. The storage node 100 is operated by SDS software. Hence, reconfiguration of the storage devices in the storage node 100 can be available by individual software or hardware.

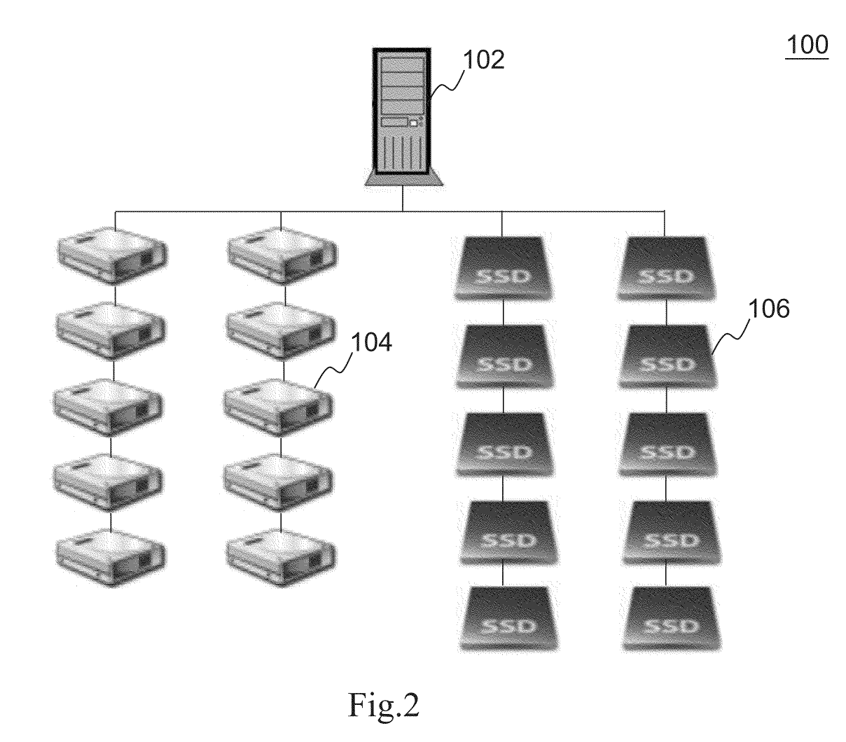

Please see FIG. 2. FIG. 2 shows the architecture of the storage node 100. The storage node 100 includes a managing server 102, 10 HDDs 104 and 10 SSDs 106. The managing server 102 can receive commands to processes reconfiguration of the HDDs 104 and SSDs 106. Different configuration of storage node 100, the percentages of the HDDs 104 and SSDs 106 in use, can maintain a certain value of latency under different workload. The SSD 106 has faster storage speed than the HDD 104. However, cost of the SSD 106 is much expensive than that of HDD 104 for similar capacity. Normally, storage capacity of the HDD 104 is around ten times as that of the SSD 106. It is not economic for such storage node 100 to provide the service with all SSDs 106 standby because life cycles of the SSDs 106 will drop very fast and storage capacity will soon become a problem when the SSDs 106 are almost fully utilized. When the configuration of the storage node 100 contains some HDDs 104 and SSDs 106, as long as the value of latency can fulfill the request in a Service Level Agreement (SLA) or a Quality of Service (QoS) requirement, the storage node 100 can still run well and avoid the aforementioned problems.

The adaptive quick response controlling system 10 includes a traffic monitoring module 120, a calculation module 140, an adaptive dual neural module 160 and a quick response control module 180. The traffic monitoring module 120 is used to acquire an observed value of latency in the storage node 100. The calculation module 140 can calculate a difference value between one observed value and a specified value of the latency and pass the calculated difference value to the adaptive dual neural module 160 and the quick response control module 180. Here, the specified value of the latency is the request in the SLA or QoS. It is the maximum latency the storage node 100 should perform for the service it provides under normal use (may be except in the storage node 100 booting or under very huge workload). For this embodiment, the specified value of the latency is 2 seconds. Any specified value is possible. It is not limited by the present invention.

The adaptive dual neural module 160 is used to learn best configurations of the HDDs 104 and SSDs 106 in the storage node 100 under various difference values, from historical records of configurations of the HDDs 104 and SSDs 106 and associated observed values. The difference values are between the observed values and the specified value of the latency. It can also provide the best configurations to the quick response control module 180. The adaptive dual neural module 160 works when a current difference value is not smaller than a threshold value. The current difference value means the newest difference value between the observed value from the traffic monitoring module 120 and the specified value of the latency, 2 seconds. The threshold value is a preset time over the specified value of the latency. Since the time over the specified value of the latency is too short, it is not worthy changing configuration of the HDDs 104 and SSDs 106 to reduce the latency and current configuration can remain to work. The threshold value in the present embodiment is 0.2 second. Of course, it can vary for different service provided by the storage node 100.

In order to implement the functions that the adaptive dual neural module 160 provides, the adaptive dual neural module 160 can further include two major parts, a constant neural network (CNN) element 162 and an adaptive neural network (ANN) element 164. The constant neural network element 162 provides the best configurations which are preset before the adaptive quick response controlling system 160 functions. It is initiated when the current difference value is not smaller than a tolerance value. Here, the tolerance value is an extra time over the specified value of the latency. Once the tolerance value is observed, some urgent treatments must be taken to fast reduce the latency so that the client doesn't have to wait the feedback from the storage node 100 too long in the coining few seconds. Operation of the constant neural network element 162 can be deemed as a brake for the latency to be enlarged with the workload. In practice, the tolerance value should be less than or equal to a preset value. Preferably, it is lesser than or equal to 3 seconds. Therefore, it is set to 3 seconds in the present embodiment.

The adaptive neural network element 164 is used to learn the best configurations of the HDDs 104 and SSDs 106 in the storage node 100 under various difference values from historical records of configurations of the HDDs 104 and SSDs 106 and associated observed values in a long period. It can also provide the best configurations. The adaptive neural network element 164 works when the current difference value is smaller than the tolerance value but not smaller than the threshold value. The long period may range from tens of seconds to the whole period of the historical records of the storage node 100. Any record of the storage node 100 able to be provided as a material for the adaptive neural network element 164 to learn the best configurations of the HDDs 104 and SSDs 106 is workable. It is better to use latter ones. It is appreciated that some observed values in the long period is not continuously recorded. Some records may be missed. The adaptive neural network element 164 still can use the discontinuous records.

Since the complexity of hardware of the storage node 100 and different workloads from the requests of clients will cause different latency to the storage node 100, there is no specified relationship between the latency and the workload with time. The best way for the adaptive quick response controlling system 10 to have a controlling method for the storage node 100 is to learn the relationship by itself Therefore, a neural network algorithm is a good way to meet the target. Learning the best configurations of the HDDs 104 and SSDs 106 can be achieved by the neural network algorithm. Although there are many neural network algorithms, the present invention is not to restrict which one to use. Setting of parameters in the different layers in the model of each algorithm can be built with the experiences from other systems.

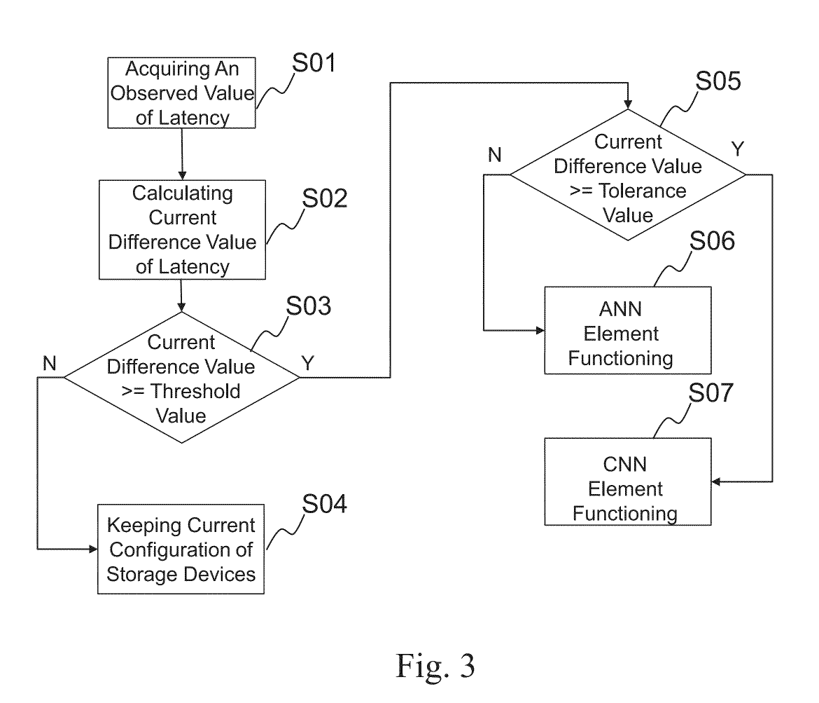

In order to know how the adaptive dual neural module 160 works, please refer to FIG. 3. FIG. 3 is a flow chart of operation of the adaptive dual neural module 160. After an observed value of the latency is acquired by the traffic monitoring module 120 (S01) and the calculation module 140 calculates the current difference value of the latency (S02), the adaptive dual neural module 160 will judge if the current difference value is not smaller than the threshold value, 0.2 second (S03). If yes, the current configuration of the HDDs 104 and SSDs 106 keeps (S04); if no, the adaptive dual neural module 160 will judge if the current difference value is not smaller than the tolerance value, 3 seconds (S05). If no, the adaptive neural network element 164 operates (S06); if yes, the constant neural network element 162 operates (S07). It is obvious that when the constant neural network element 162 operates, the adaptive neural network element 164 stops operating or when the adaptive neural network element operates 164, the constant neural network element 162 stops working.

The quick response control module 180 can change a current configuration of the HDDs 104 and SSDs 106 in the storage node 100 as the best configuration of the HDDs 104 and SSDs 106 provided from the adaptive dual neural module 160 if the current difference value is not smaller than the threshold value. Thus, the quick response control module 180 can always use the best configuration from the adaptive dual neural module 160 to adjust the configuration for the storage node 100. The current difference value will be reduced after the best configuration is adopted.

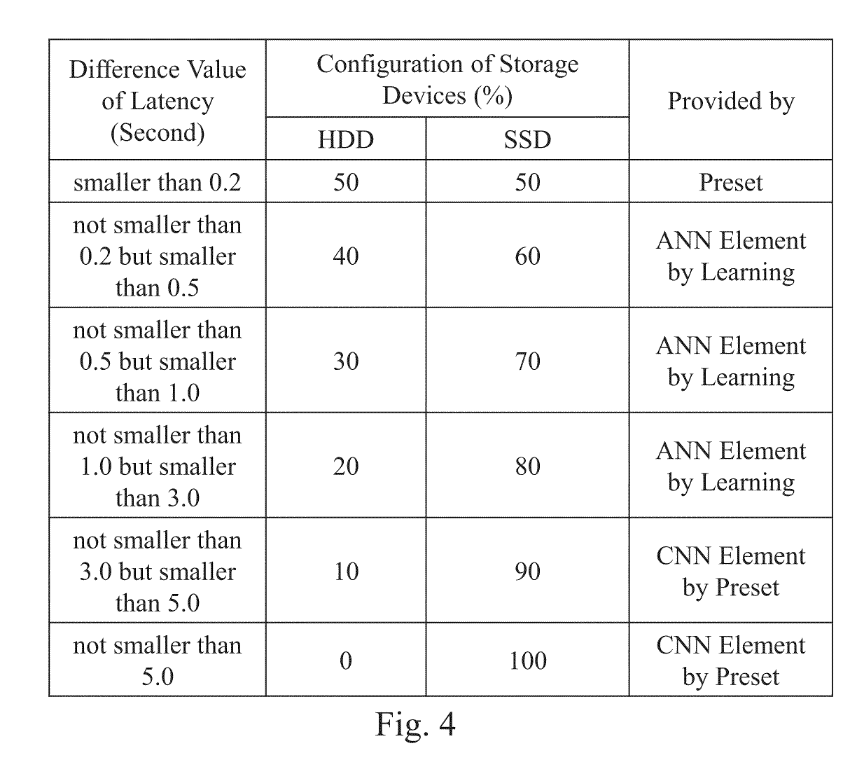

Please see FIG. 4. It is a table for the best configuration from the adaptive dual neural module 160 in the present embodiment. When the storage node 100 runs with latency smaller than 2 seconds, the configuration contains 50% of HDDs 104 and 50% of SSDs 106. Even the difference value of the latency is within 0.2 second (the latency is 2.2 seconds), since the difference value of the latency is still smaller than the threshold value, the adaptive dual neural module 160 won't operate and the configuration remains the same. When the difference value of the latency increases to over 0.2 second, the adaptive neural network element 164 operates to learn the best configuration of the HDDs 104 and SSDs 106 with historical records and some new received data which will be deemed as historical records for learning. Meanwhile, based on the learned results in the past, the adaptive neural network element 164 provides the quick response control module 180 that when the difference value of the latency is not smaller than 0.2 second but smaller than 0.5 second, the best configuration is 40% of HDDs 104 and 60% of SSDs 106; when the difference value of the latency is not smaller than 0.5 second but smaller than 1.0 second, the best configuration is 30% of HDDs 104 and 70% of SSDs 106; when the difference value of the latency is not smaller than 1.0 second but smaller than 3.0 seconds, the best configuration is 20% of HDDs 104 and 80% of SSDs 106. Of course, the best configuration could be changed from further learning out of the available historical records since behavior patterns of the clients may be changed in the future. After new best configuration is applied under different value of the latency, the latency will soon become smaller than the specified value, 2 seconds. It should be noticed that the number of total segments for the best configuration is not limited to 6 as described above. It can be greater than 6 or smaller than 6. For example, the number of the segments for difference value of the latency falls between the threshold value and the tolerance value may be 5. Namely, each 0.5 second is a segment. Thus, in this embodiment, the number of the total segment becomes 8, rather than 6. It is because the best configuration learned by the adaptive dual neural network module 160 depends on the types of requirements of applications (i.e. workload) and hardware specifications of HDDs and SSDs in the storage node 100.

When the difference value of the latency is not smaller than the tolerance value, a moderate change of configuration is too late. Under this situation, an enforced means should be taken to fast reduce the latency. Thus, the constant neural network element 162 operates and the adaptive neural network element 164 stops operating. The constant neural network element 162 will provide the preset best configuration for the HDDs 104 and of SSDs 106. According to the present embodiment, when the difference value of the latency is not smaller than 3.0 seconds but smaller than 5.0 seconds, the best configuration is 10% of HDDs 104 and 90% of SSDs 106; when the difference value of the latency is not smaller than 5.0 seconds, the best configuration is 0% of HDDs 104 and 100% of SSDs 106. In this extreme case, all SSDs 106 are used.

However, although both the constant neural network element 162 and the adaptive neural network element 164 can provide the best configuration, it can be seen from FIG. 4 that change amount between the best configuration provided by the constant neural network element 162 and the current configuration (50% of HDDs 104 and 50% of SSDs 106) is greater than that between the best configuration provided by the adaptive neural network element 164 and the current configuration.

As mentioned above, the latency is just one performance parameter requested by the SLA. Other performance parameters can be changed with the same method to adjust configuration of the HDDs 104 and SSDs 106 to be changed. For example, IOPS and throughput can be increased as the SSDs 106 are increased.

It should be emphasized that the storage devices are not limited to HDD and SSD. Random Access Memories (RAMs) can be used. Thus, a combination of HDDs and RAMs or SSD and RAMS are applicable. The best configuration in the embodiment is percentages of different types of storage devices in use. It can be a fixed quantity of storage devices of single type in use (e.g., the storage node contains SSDs only and reconfiguration is done by adding new or standby SSD). Most important of all, the traffic monitoring module 120, calculation module 140, adaptive dual neural module 160 and quick response control module 180 can be hardware or software executing on at least one processor in the storage node 100.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. An adaptive quick response controlling system for a software defined storage (SDS) system to improve a performance parameter, comprising:
a traffic monitoring module, for acquiring an observed value of the performance parameter in a storage node;
an adaptive dual neural module, for learning best configurations of a plurality of storage devices in the storage node under various difference values between the observed values and a specified value of the performance parameter from historical records of configurations of the storage devices and associated observed values, and providing the best configurations when a current difference value is not smaller than a threshold value; and
a quick response control module, for changing a current configuration of the storage devices in the storage node as the best configuration of the storage devices provided from the adaptive dual neural module if the current difference value is not smaller than the threshold value,
wherein the storage node is operated by SDS software and the current difference value will be reduced after the best configuration is adopted.

2. The adaptive quick response controlling system according to claim 1, wherein the adaptive dual neural module comprises:
a constant neural network element, for providing the best configurations which are preset before the adaptive quick response controlling system functions when the current difference value is not smaller than a tolerance value; and
an adaptive neural network element, for learning the best configurations of the storage devices in the storage node under various difference values from the historical records of configurations of the storage devices and associated observed values in a long period and providing the best configurations when the current difference value is smaller than the tolerance value but not smaller than the threshold value.

3. The adaptive quick response controlling system according to claim 2, wherein when the constant neural network element operates, the adaptive neural network element stops operating or when the adaptive neural network element operates, the constant neural network element stops working.

4. The adaptive quick response controlling system according to claim 2, wherein the tolerance value is less than or equal to a preset value.

5. The adaptive quick response controlling system according to claim 4, wherein the preset value is 3 seconds.

6. The adaptive quick response controlling system according to claim 2, wherein the long period ranges from tens of seconds to a period of the historical records.

7. The adaptive quick response controlling system according to claim 2, wherein the observed values in the long period is not continuously recorded.

8. The adaptive quick response controlling system according to claim 2, wherein a change amount between the best configuration provided by the constant neural network element and the current configuration is greater than that between the best configuration provided by the adaptive neural network element and the current configuration.

9. The adaptive quick response controlling system according to claim 2, wherein learning the best configurations of the storage devices is achieved by Neural Network Algorithm.

10. The adaptive quick response controlling system according to claim 1, wherein the specified value is requested by a Service Level Agreement (SLA) or a Quality of Service (QoS) requirement.

11. The adaptive quick response controlling system according to claim 1, wherein the performance parameter is Input/Output Operations per Second (IOPS), latency or throughput.

12. The adaptive quick response controlling system according to claim 1, wherein the storage devices are Hard Disk Drives (HDDs), Solid State Drives, Random Access Memories (RAMs) or a mixture thereof.

13. The adaptive quick response controlling system according to claim 1, wherein the best configuration is percentages of different types of storage devices or a fixed quantity of storage devices of single type in use.

14. The adaptive quick response controlling system according to claim 1, further comprising a calculation module, for calculating the difference value and passing the calculated difference value to the adaptive dual neural module and the quick response control module.

15. The adaptive quick response controlling system according to claim 1, wherein the traffic monitoring module, adaptive dual neural module, quick response control module or calculation module is hardware or software executing on at least one processor in the storage node.
